(19) United States
(12) Patent Application Publication
(10) Pub. No.: US 2022/0277723 A1
(43) Pub. Date: Sep. 1, 2022

(54) NOISE REDUCTION DEVICE AND METHOD

(71) Applicants: Bonn-Hee Goo, Gyeonggi-do (KR); Seung-Geun Hong, Gyeonggi-do (KR); Dong-Jun Kim, Gangnam-gu, Seoul (KR)

(72) Inventors: Bonn-Hee Goo, Gyeonggi-do (KR); Seung-Geun Hong, Gyeonggi-do (KR); Dong-Jun Kim, Gangnam-gu, Seoul (KR)

(21) Appl. No.: 17/631,768

(22) PCT Filed: Jul. 24, 2020
(86) PCT No.: PCT/KR2020/009810

§ 371 Date: Jan. 31, 2022

(30) Foreign Application Priority Data
Jul. 31, 2019 (KR) 10-2019-0093031
May 6, 2020 (KR) 10-2020-0053769

(51) Int. Cl. G10K 11/178; H04R 1/40; H04R 3/00; H04R 1/28

(52) U.S. Cl. CPC G10K 11/17823; H04R 1/406; H04R 3/005; H04R 1/288; G10K 11/17857; G10K 11/17873; G10K 2210/3046; G10K 2210/3044; G10K 2210/3027; G10K 2210/129

(57) ABSTRACT

A noise reduction device and method comprises: at least one sound pickup microphone module for picking up sound from a medium to generate a noise pickup signal; at least one speaker driver for transmitting, to the medium, a vibration corresponding to a noise cancellation signal generated on the basis of the noise pickup signal; and a controller for generating the noise cancellation signal on the basis of the noise pickup signal.

### CROSS-REFERENCE TO RELATED APPLICATIONS

This application is a national phase entry under 35 U.S.C. § 371 of International Patent Application PCT/KR2020/009810, filed Jul. 24, 2020, designating the United States of America and published as International Patent Publication WO 2021/020823 A2 on Feb. 4, 2021, which claims the benefit under Article 8 of the Patent Cooperation Treaty to Korean Patent Application Serial No. 10-2020-0053769, filed May 6, 2020, and to Korean Patent Application Serial No. 10-2019-0093031, filed Jul. 31, 2019.

### TECHNICAL FIELD

The present disclosure relates generally to a noise elimination device and method and, more particularly, to technology for generating a noise elimination signal based on a noise pickup signal picked up through a microphone module, outputting the noise elimination signal, and then eliminating noise.

### BACKGROUND

Unless a different description is made in the present specification, contents described in this section are not admitted as prior art related to the accompanying claims of this application, and are not necessarily recognized as the prior art, even if the contents are included in this section.

The most fundamental method for eliminating noise is to produce a reverse-phase signal having the same level as noise desired to be eliminated and to cancel the noise.

However, this method is possible only when the corresponding device is in close contact with the ears, as in the case of earphones or headphones, but a problem arises in that it is difficult to eliminate noise produced in a space.

Noise radiated into the air may be easily distorted by the influence of diffraction, interference, reflection, or the like, and thus it is impossible in practice to generate a signal capable of cancelling such noise.

However, if noise transferred through a medium, such as noise between floors, is eliminated at the step of passing through the medium before being radiated into the air, the noise radiated into the air may be prevented.

The method of eliminating noise at the step of passing through the medium may include a method of installing carpet or a buffering mat that enables vibrations to be attenuated in the medium or a method such as functional construction for sound absorption, and is problematic in that separate construction or additional installation is required, thus increasing costs.

Further, in cases in which it is difficult to reinforce the medium after the medium is installed together with a structure during the construction thereof, additional construction may be more difficult.

Korean Patent No. 10-1365607 registered on Feb. 14, 2014 discloses a smart TV, a noise cancellation device, and a smart TV system, which cancel noise in a separated space.

### BRIEF SUMMARY

### Technical Problem

An object of the present disclosure is to eliminate noise transferred through a medium.

Another object the present disclosure is to prevent vibration of a speaker driver installed at the same point from being transferred to a microphone module.

A further object of the present disclosure is to prevent sound leakage from occurring from a speaker driver.

Yet another object of the present disclosure is to provide a noise elimination device that can be combined with an existing appliance such as a light fixture or an air conditioner.

Still another object of the present disclosure is to analyze the position of a noise source, thus accurately eliminating the noise.

Also, objects of the present disclosure are not limited to the foregoing objects, and it will be apparent that additional objects can be derived from the following descriptions.

### Technical Solution

A noise elimination device according to an embodiment of the present disclosure to accomplish the above objects may include one or more pickup microphone modules for picking up a sound from a medium and generating a noise pickup signal, one or more speaker drivers for transferring a vibration corresponding to a noise elimination signal generated based on the noise pickup signal to the medium, and a controller for generating the noise elimination signal based on the noise pickup signal.

Here, the pickup microphone modules may be configured such that multiple pickup microphone modules are attached to the medium, and a direction corresponding to noise is detected using noise pickup signals picked up through the multiple pickup microphone modules, and the noise elimination signal is generated based on the direction.

Here, the noise pickup signals may be used to calculate a position of a sound source corresponding to the noise, and the noise elimination signal may be generated based on the position of the sound source.

Here, the speaker drivers may include multiple speaker drivers and are configured to calculate distances from respective multiple speaker drivers to the sound source and apply a delay corresponding to at least one of the distances to a noise elimination signal corresponding to at least one of the multiple speaker drivers.

Here, a part of the multiple speaker drivers may be configured to generate the noise elimination signal for eliminating the noise corresponding to the sound source, and a remaining part of the multiple speaker drivers may be configured to generate an attenuation vibration required to attenuate the vibration for eliminating the noise.

Here, the multiple pickup microphone modules and the multiple speaker drivers may be installed in a single structure attached to the medium.

Here, the noise elimination device may further include a honeycomb resonator for accommodating the one or more pickup microphone modules and the one or more speaker drivers and eliminating sound leakage occurring on rear surfaces of the speaker drivers and low-level noise transferred from the medium.

Here, the honeycomb resonator may be configured such that an internal space thereof is divided into honeycomb cell structures and a partition defining one or more honeycomb cell structures as one space is formed.

Here, the honeycomb resonator may be configured such that, in order to increase diffuse reflection of the sound leakage and the noise that are internally absorbed, heights of bottom surfaces of respective honeycomb cell structures formed in the honeycomb resonator are differently formed.

Here, the partition may be configured such that a through-hole having a size corresponding to a frequency desired to be removed from the space formed by the partition is formed in the partition.

Here, each of the speaker drivers may further include a resonance unit coupled to a rear surface of the corresponding speaker driver and formed in a multi-chamber manner to cancel sound leakage occurring in the rear surface of the speaker driver.

Here, the controller may be configured to calculate a first fundamental frequency value based on the position of the sound source and the noise pickup signal, generate a first noise elimination signal corresponding to the first fundamental frequency value, and transfer the first noise elimination signal to the corresponding speaker driver, and calculate a second fundamental frequency value based on a noise pickup signal from which a wavelength corresponding to the first fundamental frequency value is removed, generate a second noise elimination signal corresponding to the second fundamental frequency value, and transfer the second noise elimination signal to the corresponding speaker driver, and the speaker driver may be configured to transfer vibrations corresponding to the first noise elimination signal and the second noise elimination signal, transferred from the controller, to the medium in a time-series order.

Here, the controller may be configured to predict a Chladni pattern based on information about a structure of the medium, input by a user, and generate the noise elimination signal based on the pattern and the noise pickup signal.

Here, the controller may be configured to calculate a fundamental frequency value and a harmonic frequency value based on the position of the sound source and the noise pickup signal, simultaneously generate waveforms corresponding to the fundamental frequency value and the harmonic frequency value, and generate the noise elimination signal based on the simultaneously generated waveforms.

Further, a noise elimination method according to an embodiment of the present disclosure to accomplish the above objects relates to a method for eliminating noise using a noise elimination device, and includes picking up a sound from a medium through a pickup microphone module and generating a noise pickup signal, generating a noise elimination signal based on the noise pickup signal, and transferring a vibration corresponding to the noise elimination signal to the medium through a speaker driver.

Here, the pickup microphone module may be configured such that multiple pickup microphone modules are attached to the medium, and generating the noise elimination signal may include detecting a direction corresponding to noise using noise pickup signals picked up through the multiple pickup microphone modules, and generating the noise elimination signal based on the direction.

Here, generating the noise elimination signal may include calculating a position of a sound source corresponding to the noise based on the noise pickup signals, and generating the noise elimination signal based on the position of the sound source.

Here, the speaker driver may include multiple speaker drivers, and the noise elimination method may further include calculating distances from respective multiple speaker drivers to the sound source, and applying a delay corresponding to at least one of the distances to a noise elimination signal corresponding to at least one of the multiple speaker drivers.

Here, transferring the vibration to the medium may include transferring a vibration corresponding to the noise elimination signal for eliminating noise corresponding to the sound source to the medium through a part of the multiple speaker drivers, and transferring an attenuation vibration required to attenuate the vibration to the medium through a remaining part of the multiple speaker drivers.

Here, the noise elimination method may further include eliminating sound leakage and noise occurring on a rear surface of the speaker driver through a honeycomb resonator that accommodates the pickup microphone module and the speaker driver.

Here, the honeycomb resonator may be configured such that an internal space thereof is divided into honeycomb cell structures and a partition defining one or more honeycomb cell structures as one space is formed.

Here, the honeycomb resonator may be configured such that, in order to increase diffuse reflection of the noise that is internally absorbed, heights of bottom surfaces of respective honeycomb cell structures formed in the honeycomb resonator are differently formed.

Here, the partition may be configured such that a through-hole having a size corresponding to a frequency desired to be removed from the space formed by the partition is formed in the partition.

Here, generating the noise elimination signal may include calculating a first fundamental frequency value based on the noise pickup signal, generating a first noise elimination signal corresponding to the first fundamental frequency value, calculating a second fundamental frequency value based on a noise pickup signal from which a wavelength corresponding to the first fundamental frequency value is removed, and generating a second noise elimination signal corresponding to the second fundamental frequency value, and transferring the vibration to the medium may include sequentially transferring vibrations corresponding to the first noise elimination signal and the second noise elimination signal to the medium through the speaker driver.

Here, generating the noise elimination signal may include predicting a Chladni pattern based on information about a structure of the medium input by the user, and generating the noise elimination signal based on the pattern and the noise pickup signal.

Here, generating the noise elimination signal may include calculating a fundamental frequency value and a harmonic frequency value based on the noise pickup signal, simultaneously generating waveforms corresponding to the fundamental frequency value and the harmonic frequency value, and generating the noise elimination signal based on the waveforms.

### Advantageous Effects

According to the present disclosure, noise transferred through a medium may be eliminated.

Further, according to the present disclosure, the position of a noise source may be analyzed, and thus the noise can be accurately eliminated.

Furthermore, according to the present disclosure, vibration of a speaker driver installed at the same point may be prevented from being transferred to a microphone module.

Furthermore, according to the present disclosure, sound leakage from a speaker driver for eliminating noise may be blocked.

Furthermore, according to the present disclosure, there can be provided a noise elimination device that may be combined with an existing appliance such as a light fixture or an air conditioner.

The effects according to the present embodiments are not limited to the above-described effects, and other effects, not described here, may be clearly understood by those skilled in the art from the accompanying claims.

### BRIEF DESCRIPTION OF THE DRAWINGS

FIG. 1 is a perspective view of a noise elimination device according to an embodiment of the present disclosure;

FIG. 2 is an exploded view of a noise elimination device according to an embodiment of the present disclosure;

FIG. 3 is a perspective view of a honeycomb resonator according to an embodiment of the present disclosure;

FIG. 4 is a flow diagram illustrating elimination of noise according to an embodiment of the present disclosure;

FIG. 5 is a block diagram of a noise elimination device according to an embodiment of the present disclosure;

FIG. 6 is a conceptual diagram illustrating the speed of a sound wave depending on the medium;

FIG. 7 is an exploded view of a speaker driver according to an embodiment of the present disclosure;

FIG. 8 is a sectional view illustrating a speaker driver and a resonance unit according to an embodiment of the present disclosure;

FIG. 9 is an exploded view of a microphone module according to an embodiment of the present disclosure;

FIG. 10 is a conceptual diagram illustrating elimination of noise through a Fourier transform;

FIG. 11 is a conceptual diagram illustrating an allowable phase difference for eliminating noise;

FIG. 12 is a diagram illustrating an example of an extracted Chladni pattern;

FIG. 13 is a diagram illustrating examples of harmonic frequencies and a fundamental frequency in a continuous noise spectrum;

FIG. 14 is a sectional view of a microphone-embedded speaker device according to an embodiment of the present disclosure;

FIG. 15 is a conceptual diagram illustrating separation and elimination of direct sound and indirect sound according to an embodiment of the present disclosure;

FIG. 16 is a flow diagram illustrating separation and elimination of targeted frequencies according to an embodiment of the present disclosure;

FIG. 17 is a diagram illustrating an example of elimination of transaural noise according to an embodiment of the present disclosure;

FIG. 18 is a flow diagram illustrating elimination of noise using multiple microphones according to an embodiment of the present disclosure;

FIG. 19 is a diagram illustrating an example of an operating state via a display device according to an embodiment of the present disclosure;

FIG. 20 is a conceptual diagram illustrating calculation of the position of a sound source through multiple microphones according to an embodiment of the present disclosure;

FIG. 21 is a flow diagram illustrating calculation of the position of a sound source according to an embodiment of the present disclosure;

FIG. 22 is a conceptual diagram illustrating classification of noise processing depending on the position of a microphone according to an embodiment of the present disclosure;

FIG. 23 is a flowchart illustrating a noise elimination method according to an embodiment of the present disclosure; and

FIG. 24 is a diagram illustrating a computer system according to an embodiment of the present disclosure.

### DETAILED DESCRIPTION

The present disclosure will be described in detail below with reference to the accompanying drawings. Repeated descriptions and descriptions of known functions and configurations that have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc., of components in the drawings may be exaggerated to make the description clearer.

With regard to noise, low-pitched sounds are not heard well by human ears depending on an equal loudness contour, but have large energy, thus causing human beings to feel discomfort when human ears are exposed to such low-pitched sounds.

Since a low-pitched sound has a relatively large wavelength, it can easily pass through a wall or a structure, and thus has characteristics of strong transmitted force and easy occurrence of diffraction and interference in a portion in which density varies (e.g., the edge of a wall, entrance, windows, etc.).

Therefore, elimination of low-pitched sounds is an important aspect of noise inflow prevention.

Since a high-pitched sound has a relatively small wavelength, it cannot easily pass through a wall, and thus propagation of a high-pitched sound may be blocked through processing such as sound absorption or electric screen installation.

High-pitched sounds contain a large number of harmonic components for low-pitched sounds, and high frequencies exceeding an audible frequency band may cause discomfort even if a human being cannot directly hear the high frequencies.

An impact sound that directly causes noise between floors has transient characteristics, and transient components are present throughout the entire frequency band.

Further, an impact sound does not have a normal harmonic structure, but has high energy in a low-frequency band.

Furthermore, an impact sound has higher sound pressure than what is actually heard, but a low-pitched sound sounds quieter than the actual sound due to the characteristics of an equal loudness curve—Fletcher & Munson curves.

Also, an impact sound may be amplified while propagating through a medium, and may result in greater noise between floors by causing oscillation at a point at which the medium changes.

Hereinafter, preferred embodiments of the present disclosure will be described in detail with reference to the attached drawings.

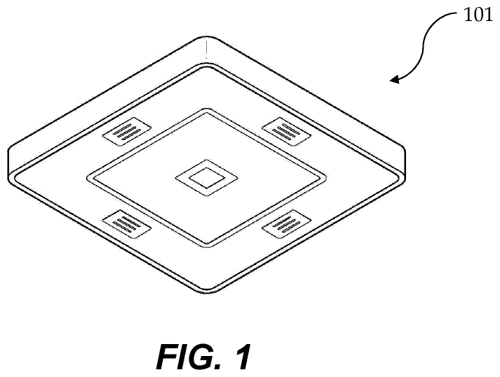

FIG. 1 is a perspective view of a noise elimination device 101 according to an embodiment of the present disclosure.

Referring to FIG. 1, the noise elimination device 101 according to an embodiment of the present disclosure may be formed in a structure in which one or more pickup microphone modules and one or more speaker drivers are attached to a medium.

In an embodiment, the structure may be attached to the ceiling, wall, or floor, or may be built into an electric/electronic appliance such as a lighting apparatus, an air conditioner, or an air cleaner.

Also, in an embodiment, the structure may be built into furniture such as a desk or bed, or may be installed at any place, such as in a vehicle in which vibration occurs.

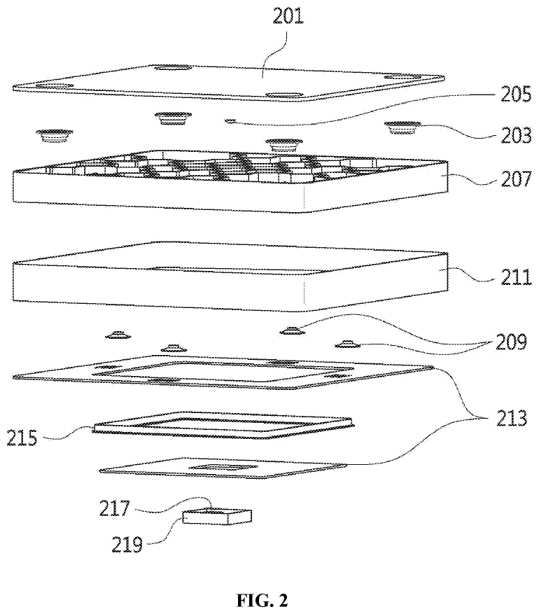

FIG. 2 is an exploded view of a noise elimination device according to an embodiment of the present disclosure.

Referring to FIG. 2, the noise elimination device according to the embodiment of the present disclosure may include an upper cover 201, a microphone-embedded speaker device 203 (or a separately included microphone module and a speaker driver), a reference microphone module 205, a honeycomb resonator 207, speaker drivers 209 for immersive reproduction, a side cover 211, a Light-Emitting Diode (LED) panel 213, a support frame 215, a display and sensor 219, and a Digital Signal Processor (DSP) 217.

Here, the upper cover 201 and the side cover 211 may be formed to accommodate internal components therein.

Here, the microphone-embedded speaker device 203 may avoid latency and reduce processing power by reducing the number of points at which pickup and reproduction is to be performed to one point.

Also, the microphone-embedded speaker device 203 may include microphone modules and speaker drivers, which may be arranged to face the same point.

Further, the microphone-embedded speaker device 203 may include microphones module and speaker drivers, in which the immersive speakers 209 having different reproduction directions may be included.

The reference microphone module 205 may be a criterion based on which the direction of incoming noise is to be detected.

Here, the reference microphone module 205 may be used to generate a reference signal for processing noise elimination driving.

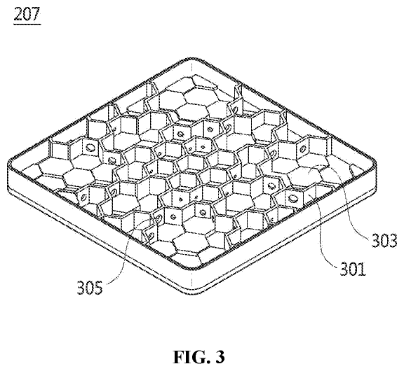

In this case, the honeycomb resonator 207 may function to eliminate sounds, produced from the rear surface of the microphone-embedded speaker device 203 or the speaker driver, and incoming noise flowing through the ceiling, based on the principle of resonation. This will be described later with reference to FIG. 3.

Here, the speaker driver 209 for immersive reproduction may eliminate noise related to indirect sound. Such indirect sound will be described in detail later.

FIG. 3 is a perspective view of a honeycomb resonator according to an embodiment of the present disclosure.

Referring to FIG. 3, the honeycomb resonator 207 according to the embodiment of the present disclosure may accommodate one or more pickup microphone modules and one or more speaker drivers, and may eliminate sound leakage occurring on the rear surfaces of the speaker drivers and low-level noise transferred from a medium.

The noise elimination device using multiple speaker drivers transfers vibrations to the medium through the speaker drivers, wherein noise produced on the rear surfaces of the speaker drivers may flow into an internal space and may cause additional noise, regardless of whether the noise has been eliminated.

In this case, the internal space of the honeycomb resonator 207 is divided into honeycomb cell structures, and is configured such that partitions 301 for defining one or more honeycomb cell structures as one space.

More specifically, the internal space of the honeycomb resonator 207 has honeycomb cell structures therein, which have different areas, and thus noise produced in the speaker drivers may be eliminated based on the principle of a Helmholtz resonator.

Here, the partitions may be used to form the volume of the resonator and divide the area of the resonator. For example, one space is formed using eight honeycomb cells by one partition 301 so as to eliminate low-pitched sounds, one space is formed using four honeycomb cells by one partition 301 so as to eliminate middle-pitched sounds, and one space is formed using one honeycomb cell by one partition 301 so as to eliminate high-pitched sounds.

According to the Helmholtz theory, the reason for this is that a space having a large area enables low-pitched sounds to be eliminated and a space having a small area enables high-pitched sounds to be eliminated.

Here, in the partitions 301, holes 305 having different sizes corresponding to targeted frequencies may be formed so as to optimize the targeted frequencies.

Further, the honeycomb resonator 207 may use a sound-absorption material therein so as to efficiently absorb sound corresponding to noise.

Furthermore, the honeycomb resonator 207 may be formed such that, in order to increase diffuse reflection of the sound leakage and the noise absorbed therein, the bottom surfaces 303 of respective honeycomb cell structures formed in the honeycomb resonator 207 are different from each other.

FIG. 4 is a flow diagram illustrating elimination of noise according to an embodiment of the present disclosure.

Referring to FIG. 4, the embodiment of the present disclosure may pick up a noise signal through a contact microphone including multiple microphones and pre-amplifiers.

Here, the level of the picked-up noise signal is measured by an input processor so that the noise signal is operated at a specific level by a gate, unnecessary frequencies may be cut off by a filter, and gain, corresponding to an output level, may be automatically controlled through an Auto-Gain Controller (AGC).

Here, a multi-channel spectrum analyzer may analyze the spectrum of the noise signal for respective channels, may analyze the position and direction of a sound source through analysis of transient time difference, and may detect a frequency at which an impact sound is produced through spectrum analysis.

Also, the multi-channel spectrum analyzer may analyze frequencies and volumes exceeding a reference level, and may secure the peak point of a target frequency.

Here, a phase comparator may predict, in advance, the shape of wavelengths, which vary when the spectrum of input frequencies is analyzed and sounds are reproduced through a multi-channel speaker at the time of output.

Here, a learning processor may analyze the Attack time, Decay time, Sustain level, and Release time (ADSR) of frequently occurring noise, and may obtain and learn data in which the flow of a peak is detected through spectrum analysis.

Here, a phase processor may perform calculation for generating an accurate reverse-phase signal of the noise signal, and may perform settings such that a reverse phase appears only at a frequency exceeding a reference. Also, the phase processor may track the wavelengths corresponding to peaks for respective frequencies, and may optimize the reverse-phase signal based on the data learned by the learning processor.

In this case, a speaker controller may control the wavelengths optimized by multiple speakers, and may extract the wavelength expected to be changed by a combination of multiple speakers.

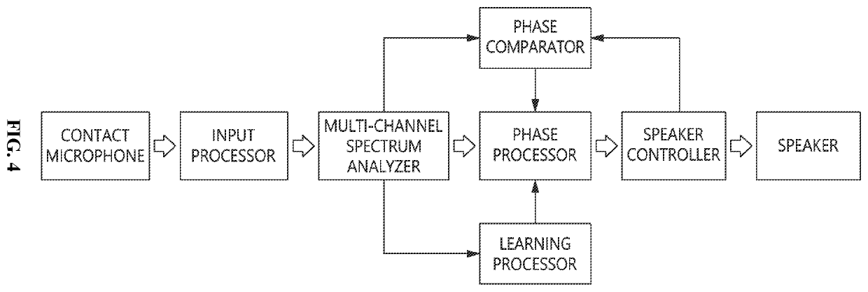

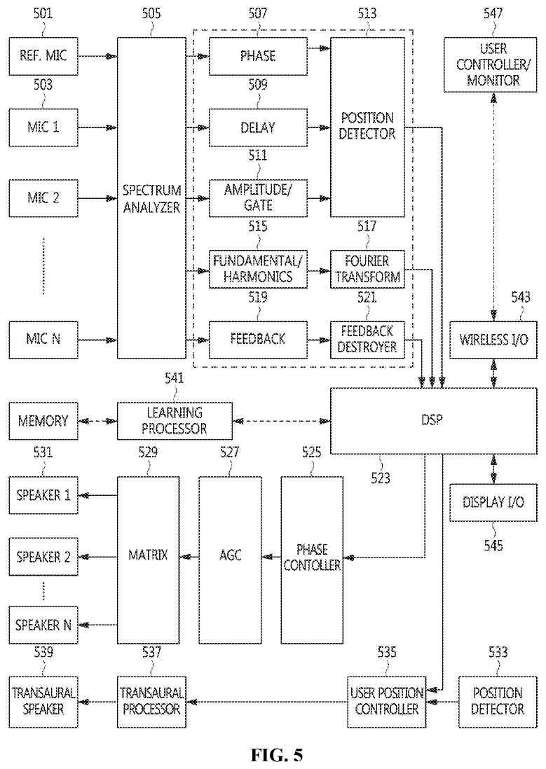

FIG. 5 is a block diagram of a noise elimination device according to an embodiment of the present disclosure.

Referring to FIG. 5, a reference microphone (REF.MIC) 501 may be the microphone that is the reference when multiple microphones are used, and may be a reference based on which input signals from N microphones are compared with each other.

Here, the reference microphone (REF.MIC) 501 may be attached to the center of a device and configured to recognize the direction of a noise source and to pick up a signal to be used as the reference for audio processing, and may be a contact microphone or a piezoelectric microphone.

Microphones (MIC(N)) 503 may be separate microphone modules or microphone modules embedded in a microphone-embedded speaker device, or may be contact microphones or piezoelectric microphones.

Here, the microphones MIC (N) 503 may detect the direction and distance of the noise source, together with REF.MIC 501, and may pick up the signal to be used as the reference for audio processing.

A spectrum analyzer (SPECTRUM ANALYZER) 505 may extract basic audio data, such as a fundamental frequency, harmonic frequencies, a level, a delay, ADSR, and a noise floor, from the signals input through respective microphones.

A phase comparator (PHASE COMPARATOR) 507 may be a comparator for comparing phases, and may analyze the phases of N microphones based on REF.MIC 501 and transfer analyzed waveforms to a position detection processor.

A delay comparator 509 may be a signal delay comparator, and may analyze delay values for N microphone inputs based on REF.MIC 501 and transfer analyzed values to the position detection processor.

An amplitude/gate comparator (AMPLITUDE/GATE COMPARATOR) 511 may be an amplitude gate comparator, and may transfer audio level values for N microphone inputs based on REF.MIC 501 to the position detection processor, compare the background noise levels of all microphones with each other, and determine whether to perform processing and bypass.

A fundamental/harmonics analyzer (FUNDAMENTAL/HARMONICS ANALYZER) 515 may be a fundamental and harmonics analysis device, and may detect a fundamental frequency from frequency components analyzed through a spectrum, analyze harmonic frequencies for the corresponding frequency, and transfer the analyzed results to a Fourier transform device.

A feedback detector (FEEDBACK DETECTOR) 519 may be a feedback detection device, and may be configured to, when a feedback signal is detected, transfer a frequency value corresponding to the detected frequency to a feedback destroyer.

A position detector (POSITION DETECTOR) 513 may be a position detection device, and may analyze the position of a noise source by analyzing phases, delays, and levels input through the multiple microphones and transfer analyzed direction information and analyzed values to a DSP.

A Fourier transformer (FOURIER TRANSFORM) 517 may be a Fourier transform device, and may be configured to analyze a fundamental frequency, analyze harmonic frequencies, and produce a reverse-phase signal or use the analyzed frequencies as the data to be verified through the DSP.

A feedback destroyer (FEEDBACK DESTROYER) 521 may be a feedback removal device, and may be configured to block a frequency causative of feedback, detected by the feedback detector.

A comparator module (COMPARATOR MODULE) may be a comparator device, and may be configured to track the position of a noise source by analyzing signal aspects such as phases, delays, or levels and to generate a reverse-phase audio signal by analyzing audio waveforms.

A Digital Signal Processor (DSP) 523 may analyze and process the signals input through the comparator module, and may then perform composite operations on noise elimination signals and output the results of composite operations to multiple speakers.

Here, the DSP 523 may include a control and display function using wireless Input/Output (I/O), and may learn a noise elimination function through a learning processor.

A phase controller (PHASE CONTROLLER) 525 may be a phase control device, and may control the phases of N output signals that are output through the DSP 523.

An Auto-Gain Controller (AGC) 527 may be an auto-level controller, and may control the gains of N outputs that are output through the DSP 523.

A matrix (MATRIX) 529 may be a matrix controller, and may control a signal matrix for transferring N output signals, for which phase and gain control has been completed, to the speakers.

Speakers (SPEAKER (N)) 531 may be noise elimination speakers, may eliminate noise from a direct sound using a signal finally output through the matrix controller, and may be exciter-type speakers that directly transfer vibrations to a medium.

A position detector (POSITION DETECTOR) 533 may be a position detection device, and may detect the position at which the user is located and transfer a signal to a user position controller.

A user position controller (USER POSITION CONTROLLER) 535 may be a user position control device, and may automatically detect the position through the position detector or generate a transaural signal in an area designated by the user using a transaural processor for the corresponding area.

A transaural processor (TRANSAURAL PROCESSOR) 537 may be a transaural processing device, and may eliminate high frequencies, which cannot be eliminated from direct sound, through a transaural sound. In this case, the signal output through the matrix controller may be converted into transaural sound, and the transaural sound may be transferred to a transaural reproduction speaker.

A transaural speaker (TRANSAURAL SPEAKER) 539 may be a transaural reproduction speaker, may eliminate room noise using the signal received through the transaural processor, and may be a loudspeaker device.

A learning processor (LEARNING PROCESSOR) 541 and memory (MEMORY) may be a processor for learning and a storage device, respectively, and may be configured to store frequently occurring noise as learning data, and when noise that is the same as the stored data occurs, store and reproduce a reverse-phase waveform that can completely eliminate the noise.

Wireless input/output (WIRELESS I/O) 543 may be a wireless input/output device, and may be a mobile device such as a remote control, a personal computer (PC), or a smartphone, and may include any type of device that is capable of transferring a control command from the user or transferring information detected by the DSP 523 and the detection device to the user.

A user controller/monitor (USER CONTROLLER/MONITOR) 547 may be a user controller and a monitor, and display I/O (DISPLAY I/O) 545 may be a display input/output device.

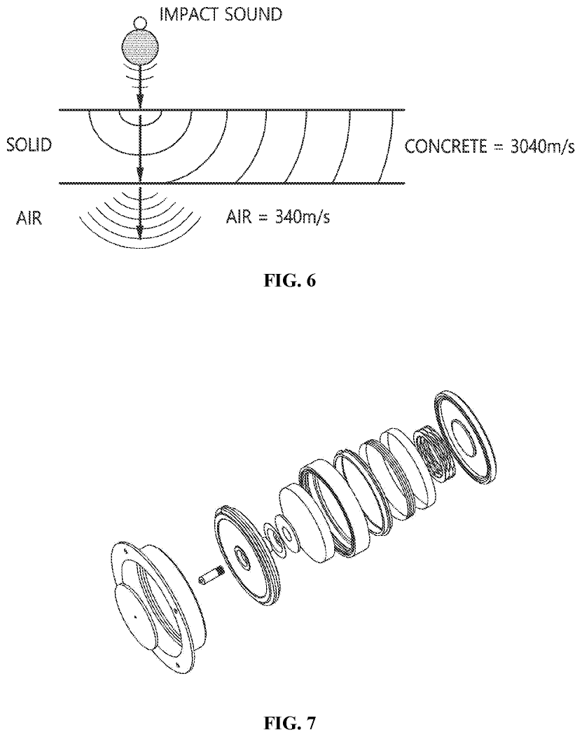

FIG. 6 is a conceptual diagram illustrating the speed of a sound wave depending on the medium.

Generally, noise moves along a medium, and the medium vibrates air and produces noise.

Here, noise already radiated into the air may be distorted by the influence of diffraction, reflection, interference, or cancellation, and thus it is difficult to eliminate such noise even if a reverse-phase signal is generated.

Therefore, it is preferable to eliminate noise propagating along the medium at a medium propagation step before being radiated into the air, and it may be possible to pick up noise propagating along the medium and transfer a reverse-phase signal corresponding to the noise to the medium, thus eliminating the noise.

However, in the case of sound speeds, the propagation speed of sound in the air and the propagation speed in a specific medium are different from each other, so when a reverse-phase signal is generated based on a typical sound speed, noise elimination cannot be accurately performed.

Referring to FIG. 6, the speed of sound in the air is 340 m/s, whereas the speed of sound in concrete, among (solid) media, is 3040 m/s, and thus the speed difference therebetween is very large.

Also, the frequency propagating through the medium is not changed, but only the speed of the transferred sound is changed, whereby the sizes of wavelengths may vary.

Because noise elimination must be performed to eliminate noise by reproducing a reverse wavelength corresponding to a sound wave, the wave of sound reproduced through the speaker must be transferred to the medium while a diaphragm comes into contact with the medium rather than the air, and an exciter speaker capable of setting up vibrations in the medium may be used.

The speed of a sound wave corresponding to a targeted medium may be defined by the following Equation 1.

$$V = \sqrt{\frac{B}{ρ}} , ρ = \frac{M}{V} , B = \frac{- δ P}{δ V / V} \qquad [ Equation 1 ]$$

Here, p is the density (in kg/m\hat{ }3) of the medium, B is the elastic coefficient (in N/m\hat{ }2) of a bulk module, P is pressure, and V is velocity.

By means of Equation 1, the speed of a sound wave in the medium may be known, and a wavelength value corresponding to frequency may be obtained using the following Equation 2.

$$λ = \frac{V}{f} \qquad [ Equation 2 ]$$

Here, since the speed of sound in the medium may be known and the frequency of the sound may be known, the exact wavelength of the sound may be extracted, and the phase of the sound may be reversed by applying a reverse phase to the wavelength.

Through the above-described scheme, sound flowing into a noise source may be picked up through a contact microphone, and a vibration having a reverse phase may be transferred to the medium through the exciter speaker, thus enabling the noise to be cancelled.

FIG. 7 is an exploded view of a speaker driver according to an embodiment of the present disclosure.

In order to transfer a vibration to a medium having high density, a speaker device having sufficient vibrational energy is required.

Referring to FIG. 7, the speaker driver according to the embodiment of the present disclosure may be directly attached to a medium, and may be formed to transfer vibrations.

Here, the vibration unit of the speaker driver, which produces vibrations, may be implemented using an element having the same density as the medium, and may be implemented as an element that can produce vibrations even at low power, thus amplifying vibrations.

In this case, the reproduction characteristics of the speaker driver (diaphragm) may be adjusted so that high-pitched sound components (having a frequency of 1 kHz or higher) are not reproduced, and the amplification unit of signals may include a low-pass filter (LPF) so as to maintain the reproduction characteristics.

When a description is made in greater detail with reference to FIG. 7, the speaker driver according to the embodiment of the present disclosure may include the vibration unit, a magnet, a voice coil, a voice coil holder, and a fixing bracket, and may be attached to a medium to produce vibrations.

Here, the voice coil generates a magnetic field in response to a reverse-phase signal applied through the microphone module.

Here, the signal may be a sound signal that is output to the speaker driver, and may move the magnet through the magnetic field.

Here, the voice coil holder may accommodate respective components, and may fix the location of the voice coil from outside the voice coil.

Here, the voice coil may prevent the location thereof relative to the medium from changing by utilizing the voice coil holder.

Here, the voice coil may be located within the voice coil holder, and the location thereof relative to the magnet may be varied.

The reason for varying the relative location is to exploit variation in sound characteristics depending on the location of the voice coil relative to the magnet.

Generally, the voice coil and the magnet must be located at the position corresponding to ½ of the voice coil. When the voice coil and the magnet are moved farther away from each other, a decrease in power and deterioration of low-pitched sounds may occur, thereby enabling only high-pitched sounds to be heard, whereas when the voice coil and the magnet are closer to each other, power may rise, and low-pitched sounds may increase.

Therefore, the speaker driver according to an embodiment of the present disclosure enables the location of the magnet or the voice coil to be moved in detail from outside the speaker driver, thus controlling efficiency and sound quality to degrees desired by the user.

Here, the speaker driver according to the embodiment of the present disclosure may further include a voice coil support, disposed in the voice coil holder and configured such that a fixing groove for holding the voice coil is formed in an inner circumferential surface thereof and a first screw thread is formed in an outer circumferential surface thereof, wherein the voice coil is fixed in the holding groove and a second screw thread corresponding to the first screw thread is formed in an inner circumferential surface of the voice coil holder, thus enabling the location of the voice coil support to be varied by the rotation of the voice coil holder.

Here, the magnet may be located inside the voice coil, and may be moved by the magnetic field.

Here, the movement may be vertical vibration, and the vibration of the magnet may be transferred to the vibration unit.

Here, a first surface of the vibration unit comes into contact with the medium, and then the vibration unit may transfer the vibration transferred thereto to the medium.

Here, the vibration unit may be formed in a parabolic shape, may include a microphone receiving part inwardly recessed on a side surface thereof that comes contact with the medium, and the microphone module may be disposed in the microphone receiving part in the state of being spaced apart from the vibration unit.

Here, the vibration unit may have a through-hole formed in the center thereof, a microphone module support pole may be located to penetrate the through-hole and may be fixed by a rubber ring, and a first end of the microphone module support pole may be fixedly coupled to the microphone module or a feedback-blocking housing of the microphone module.

Here, a suspension ring may be included so as to prevent the vibration unit from breaking when impacts are accumulated as vibrations are exchanged between the vibration unit and the magnet, and may be made of a flexible material.

Here, a support spring disposed on one surface of the magnet may be further included such that, after the magnet has vibrated, the magnet returns to its original location.

The support spring may be a wave spring having a multi-layer structure.

Here, the support spring is configured such that the thickness of the wave spring having multiple layers is differently set, whereby a response speed may be improved at low power, and a problem of occurrence of distortion may be solved even at high power.

For example, the wave spring according to an embodiment of the present disclosure may have a multi-layer structure including layer a, layer b, and layer c, wherein the thicknesses of respective layers satisfy a<b<c.

Here, in the wave spring, during reproduction of low-power small sounds, only layer a may be moved, and during reproduction of high-power large sounds, layers a, b, and c may be moved together.

Therefore, since the wave spring according to the embodiment of the present disclosure has different spring restoring forces depending on the power, a higher restoring force may be obtained without causing distortion even if sound having very strong transient characteristics is instantaneously input, and a damping factor may be maximized.

Further, because the thickness of the wave spring may be reduced to half that of an existing spring or less, the size of a product is not increased, and deformation of the product does not occur even upon long-term usage, owing to the very high restoring force.

Furthermore, the speaker driver may further include an upper cover and a lower cover so as to accommodate respective components, and may use the voice coil holder as a side cover.

Here, in order to improve the performance of the speaker driver, the speaker driver may further include aluminum foil in an inner surface of the voice coil.

Here, a fixing bracket may be configured such that a first end thereof is fastened to the voice coil holder and a second end thereof is fastened to the medium so as to prevent the location of the voice coil relative to the medium from changing.

Also, the fixing bracket may be fastened to the medium so that the first end thereof is coupled to the upper cover.

Here, a screw thread may be formed in an inner circumferential surface of the first end of the fixing bracket, and a screw thread corresponding to the above-described screw thread may be formed in an outer circumferential surface of the voice coil holder or the upper cover, thus enabling the screw threads to be coupled to each other through mutual screw coupling.

In addition, the fixing bracket may be formed in a cylindrical shape, and may further include an outwardly extending contact portion on an outer circumference of the first end thereof, which comes into contact with the medium, and may further include one or more through-holes in the contact portion so as to be coupled to the medium.

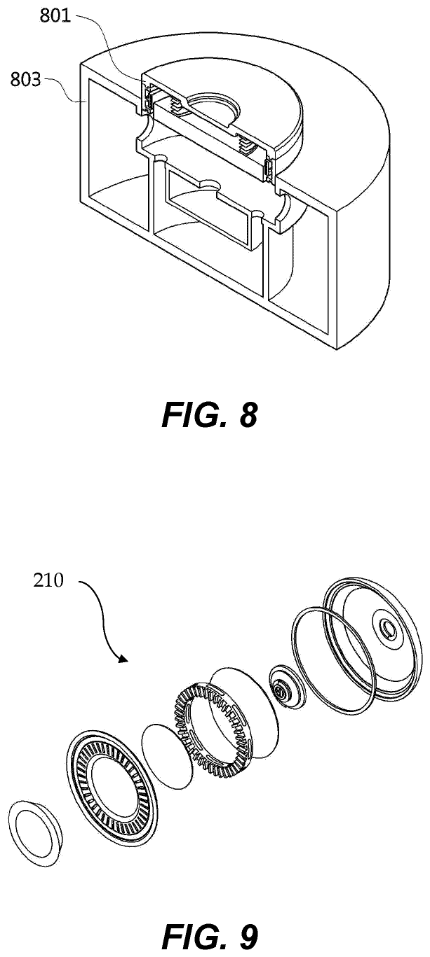

FIG. 8 is a sectional view illustrating a speaker driver and a resonance unit according to an embodiment of the present disclosure.

Referring to FIG. 8, a noise elimination device according to an embodiment of the present disclosure may further include a resonance unit 803 so as to effectively absorb and eliminate frequencies diffused to one surface of a speaker driver 801.

Here, the resonance unit 803 may be used as a housing of the speaker driver 801, and may be configured such that multiple holes are formed therein to simultaneously remove various frequencies and such that the volumes of the holes are differently formed.

$$f = \frac{c}{2 π} \sqrt{\frac{S}{L V}} \qquad [ Equation 3 ]$$

Here, f is the frequency desired to be cancelled, c is the speed of sound, S is the area of each hole, L is the distance from the hole to the resonance unit, and V is the volume of the resonance unit.

Here, the resonance unit 803 may be formed in a multi-chamber manner.

FIG. 9 is an exploded view of a microphone module according to an embodiment of the present disclosure.

Referring to FIG. 9, the microphone module according to the embodiment of the present disclosure may be implemented as a contact microphone that is capable of picking up only vibrations rather than a normal microphone so as to pick up vibration signals through a medium having a high density.

Here, the contact microphone does not pick up sounds in the air, but can pick up only frequencies vibrating through the medium.

Here, the microphone module may include a high-pitched sound contact microphone for picking up a sound from the medium by setting a first band as a target band and for generating a first pickup signal, a low-pitched sound contact microphone for picking up a sound from the medium by setting a second band, which is a frequency band lower than the first band, as a target band and for generating a second pickup signal, and a microphone controller for summing the first pickup signal and the second pickup signal and then generating a pickup signal.

Here, each of the first band and the second band may include a crossover band, and the pickup signal may correspond to the crossover band.

Here, respective negative terminals (−) of the high-pitched sound contact microphone and the low-pitched sound contact microphone may be connected to the same ground, and respective positive terminals (+) thereof may be used as individual outputs to generate a balanced audio signal (here, the balanced audio signal is robust to noise features).

The balanced audio signal has the effect of amplifying the entire signal.

The signals picked up by the high-pitched sound contact microphone and the low-pitched sound contact microphone are summed and, at this time, a crossover area in which the signals overlap each other is the band that is actually targeted.

Here, the crossover frequency may be controlled by the user.

For example, the DSP may establish the range of the crossover frequency such that the high-pitched sound contact microphone is designated as a High-Pass Filter (HPF) and the low-pitched sound contact microphone is designated as a Low-Pass Filter (LPF), thus allowing the user to control the crossover frequency.

Here, the high-pitched sound contact microphone has an area smaller than that of the low-pitched sound contact microphone, and the high-pitched sound contact microphone and the low-pitched sound contact microphone may be stacked so that central axes thereof coincide with each other while being spaced apart from each other.

Also, the microphone module according to the embodiment of the present disclosure may further include a funnel-shaped high-pitched sound boost plate, a first end of which comes into contact with the medium and which transfers the vibration of the medium to the high-pitched sound contact microphone through a second end thereof, in order to improve the pickup rate of sounds transferred from the medium.

Here, the high-pitched sound boost plate may be formed in a funnel shape to amplify small vibrations and efficiently transfer the amplified vibrations to the high-pitched sound contact microphone.

Here, as the material used to form the high-pitched sound boost plate, a material that is capable of amplifying vibrations (e.g., having a density configured to propagate sounds at the same speed as the ABS-concrete) may be used, and by means of the material, vibrations may be efficiently picked up through a medium having a higher density, through which it is difficult to pick up vibrations.

Also, the microphone module according to the embodiment of the present disclosure may further include a donut-shaped low-pitched sound boost plate, a first end of which comes into contact with the medium and which transfers the vibration of the medium to the low-pitched sound contact microphone through a second end thereof, in order to improve the pickup rate of sounds transferred from the medium.

Here, the low-pitched sound boost plate may be located such that an outer circumference thereof is coincident with an outer circumference of the low-pitched sound contact microphone, and the high-pitched sound boost plate may be located inside the internal through-hole of the low-pitched sound boost plate.

Further, the microphone module according to the embodiment of the present disclosure may further include a feedback-blocking housing that accommodates the high-pitched sound contact microphone and the low-pitched sound contact microphone and that is formed in a parabolic shape so as to improve the pickup rate.

Here, the feedback-blocking housing may be formed in a parabolic shape to amplify sounds generated from the medium, and may pick up only sounds produced in a targeted direction.

Further, the feedback-blocking housing may be formed of a magnetic-shielding material or formed in a magnetic-shielding shape, and may eliminate a feedback phenomenon because it is not influenced by the magnet of the speaker driver, as will be described later.

Furthermore, the microphone module including the feedback-blocking housing has a contact microphone form, which is not influenced by acoustic properties, and does not pick up human or ambient noise well.

Here, the feedback-blocking housing may include a rubber plate that covers an opening coming into contact with the medium.

Here, the rubber plate may be formed of a material that is capable of amplifying a targeted frequency band of the medium, and a targeted frequency may be acquired by adjusting the size and the thickness of the rubber plate.

Here, the rubber plate may improve reactivity by placing an edge on a border thereof so as to efficiently amplify and pick up the frequency.

Also, the outer border of the rubber plate may be processed in the form of a ring so as to pick up accurate sounds from a spot.

By means of the ring shape, the microphone module 210 (see FIG. 9) according to an embodiment of the present disclosure may block sound flowing from outside due to pressing when attached to the medium, and may be accurately attached to the medium, thus improving low-pitched sound pickup characteristics with an increased proximity effect.

Here, the rubber plate includes one or more through-holes formed at regular intervals along the arcs thereof, and the low-pitched sound boost plate may be located inside the rubber plate, and may include one or more projections, which correspond to the through-holes in the rubber plate and are disposed so as to pass through the through-holes in the rubber plate.

In this case, each of the high-pitched sound contact microphone and the low-pitched sound contact microphone may be at least one of a piezoelectric microphone and a laser microphone.

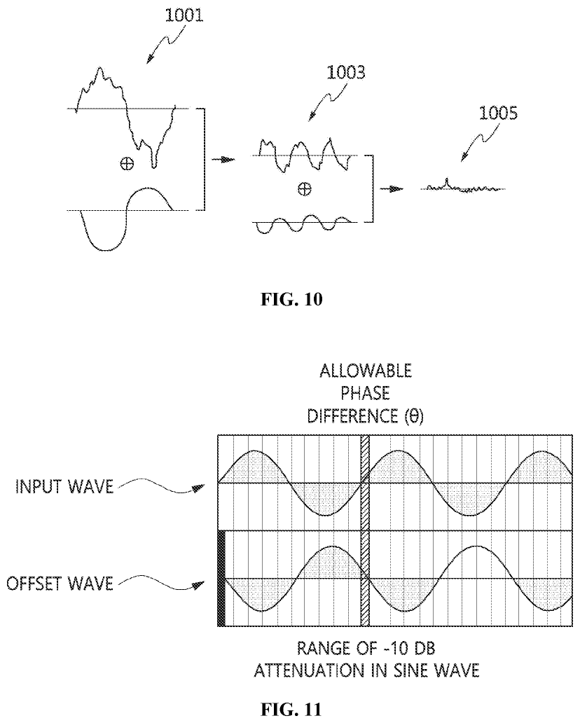

FIG. 10 is a conceptual diagram illustrating elimination of noise through a Fourier transform.

Noise is a complex sound, and frequencies thereof are uniformly distributed to the entire audible frequency band. Multiple pure sounds may be gathered to form a complex sound, but even pure sounds may be transformed into complex sounds due to reflection, refraction, diffraction, delay, or the like.

Pure sounds may be easily eliminated merely by performing reverse-phase processing thereon, but complex sounds are difficult to eliminate using only reverse-phase processing.

In addition, sounds in a low-frequency band, having relatively long wavelengths, are easily eliminated, but sounds in a high-frequency band, having relatively short wavelengths, are difficult to eliminate.

Further, a sound produced due to an impact is temporary, has a short duration, and occupies the entire frequency band.

In this case, impact sounds produced from the same medium have the same frequency form, regardless of the strength of the impact.

Here, the impact sounds have a frequency form similar to that of a percussion instrument, and this frequency oscillation may be referred to as a Chladni pattern.

When a fundamental frequency is eliminated from impact sounds having no normal harmonic structure, other harmonic frequencies may be eliminated together with the fundamental frequency, thus attenuating the overall noise.

Also, because the Chladni pattern can be applied to noise elimination at harmonic frequencies, noise attenuation characteristics may be improved.

Referring to FIG. 10, impact sounds have a wide frequency band ranging from a low band to a high band.

Here, because the wavelength of a low-pitched sound is long and the wavelength of a high-pitched sound is short, a short wavelength corresponding to the high-pitched sound is drawn on a long wavelength in a typical waveform analysis image.

Here, a first fundamental frequency value may be obtained by calculating the length of an initially generated wave.

Here, when a reverse wavelength signal corresponding to the value of the first fundamental frequency is generated and added to the original signal, the value of a second impact sound from which low-pitched sounds are eliminated may be obtained (1001).

In this case, when a second fundamental frequency value corresponding to a second impact sound is obtained using the same method and a reverse phase is applied to a wavelength corresponding to the second fundamental frequency value and is added to the original signal (1003), the value of a third impact sound from which middle- and low-pitched sounds are eliminated may be obtained (1005).

The impact sounds may be flattened (cancelled) by repeating the above-described method, and this method is identical to the principle of a Fourier transform.

However, this method is effective in elimination of frequencies in a low frequency band, but is difficult to use to eliminate frequencies in a high frequency band having a short wavelength. A scheme related thereto will be described later.

FIG. 11 is a conceptual diagram illustrating an allowable phase difference for eliminating noise.

A noise elimination method using the above-described Fourier transform must accurately form a waveform to be generated for cancellation so that the generated waveform is identical to the reverse phase of the original signal.

Also, in an offset waveform (out of phase waveform) for cancellation having a reverse phase, the reverse phase must be generated within the range of 5% of the waveform so as to obtain an attenuation effect of −10 dB or more.

V=Vₘ sin(1.9πft) [Equation 4]

Referring to Equation 4, an input wave and an offset wave need to have precisely reverse phases so as to completely eliminate noise, and the phase difference between the two waves needs to be λ/2.

Here, when the offset wave to which the reverse phase is applied has a reverse phase with respect to the input wave, the reverse phase may be located within 5% of the wavelength range, and noise attenuation characteristics of −10 dB may be obtained.

That is, when the reverse phase falls within +/−5% of the wavelength, a cancellation effect may be increased.

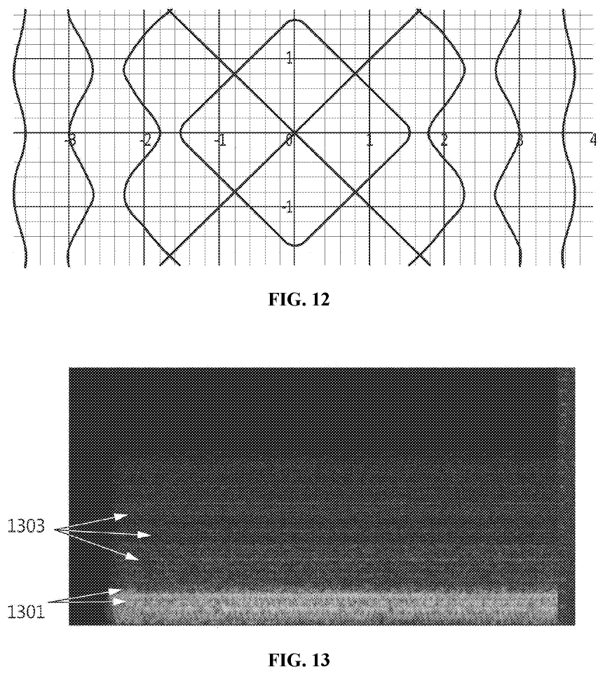

FIG. 12 is a diagram illustrating an example of an extracted Chladni pattern.

Referring to FIG. 12, assuming that an area to which noise between floors is radiated corresponds to the ceiling of a room, and the ceiling of the room is a vibrating membrane, the Chladni pattern may be applied.

In this case, the configuration of sound harmonics may be predicted by obtaining patterns related to interference and cancellation using the surface of the ceiling as a membrane.

The use of predicted values may obtain a more accurate frequency value that is not composed of harmonics, and may obtain a more accurate value by converting the density value of the material between floors into a constant.

For example, noise between floors may have multiple vibration modes because the ceiling has a rectangular structure, which can be referred to as a Chladni pattern, by which a harmonic generation structure corresponding to the rectangular membrane can be grasped.

The theory of the Chladni pattern is schematized as a general formula, as shown in the following Equation 5.

$$cos ( \frac{n π x}{L} ) cos ( \frac{m π y}{L} ) - cos ( \frac{m π x}{L} ) cos ( \frac{n π y}{L} ) = 0 \qquad [ Equation 5 ]$$

Here, the additionally generated frequency may be defined by the following Equation 6.

$$f = \frac{c}{2 L} \sqrt{{m}^{2} + {n}^{2}} \qquad [ Equation 6 ]$$

Therefore, since a noise elimination method using the Chladni pattern may recognize in advance a predicted value and a pattern change, a waveform having a reverse phase corresponding to the pattern may be generated, and the input noise may be cancelled.

FIG. 13 is a diagram illustrating examples of harmonic frequencies 1303 and a fundamental frequency 1301 in a continuous noise spectrum.

Continuous noise having a uniform pattern can be eliminated using a method for detecting the wavelength of the continuous noise and simply generating a reverse-phase signal, whereby such noise can be more easily eliminated than an impact sound.

Also, a continuous sound having a certain pattern has a lot of noise containing harmonics due to oscillations, and in this case, noise attributable to harmonics generated in a high-frequency band may be eliminated simply by eliminating the fundamental frequency 1301.

In this case, if a fundamental frequency and a wavelength can be known when eliminating noise having a harmonic structure, the noise elimination method according to an embodiment of the present disclosure may eliminate noise by generating the corresponding waveform.

Here, together with the fundamental frequency, n harmonic frequencies 1303 are simultaneously generated, and thus an audio signal similar to actual noise may be generated.

In this case, the noise elimination method according to an embodiment of the present disclosure may eliminate noise by performing reverse-phase processing on the generated signal, and this method is the same as the method for inversely utilizing a Fourier transform.

Here, the continuous sound may be effectively eliminated through audio samples (a learning function).

The learning function may collect and sample noise occurring in a place to which a noise elimination device is to be applied, and may store the collected and sampled noise in a database (DB), thus maximizing the effect of noise elimination.

Here, the learning function may collect the noise input through a microphone module as samples, and may store the samples in memory. This may be set such that the samples are stored in the memory while a noise elimination function is performed.

In this case, levels, delays, wavelengths, spectra, etc., may be analyzed from the collected samples, and the analyzed data may be stored together with the samples.

Here, the learning function may analyze the wavelength, level, or the like of noise and determine the cause of the noise, and may load a sample having a value most similar to that of the noise, apply a reverse phase to the sample, and then eliminate the noise.

The learning function may recognize a value corresponding to the shape of a waveform as a vector value and process the vector value as a method for supplementing the timing of samples, which is the most important function in noise elimination, thus reducing the time required for audio processing and actually performing a process without delay.

The collected samples may be may be stored not only in memory but also in a management server connected to the Internet.

Here, the samples stored in the server may be utilized as data for other users who use the same device or for other spaces related to the same device.

In this case, a supplier may edit the corresponding samples and re-upload the edited samples so that noise elimination is performed as effectively as possible by the noise elimination device.

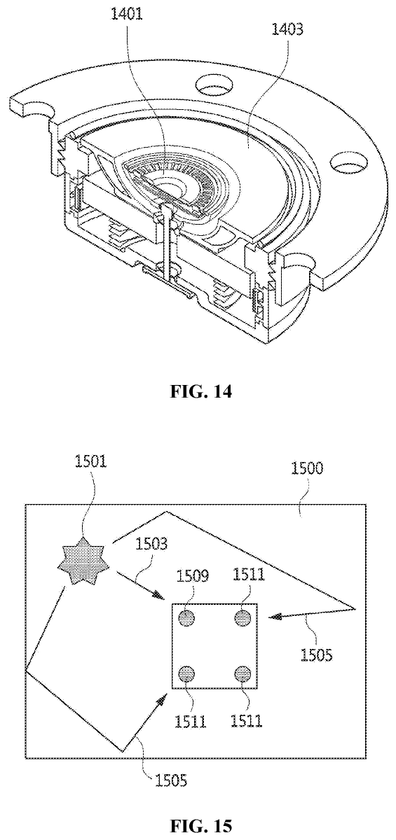

FIG. 14 is a sectional view of a microphone-embedded speaker device according to an embodiment of the present disclosure.

The basic requirement for the noise elimination method is to generate a wavelength having a reverse phase at the same position as the point at which the noise occurs, thus cancelling the noise.

Here, when a noise source is blocked by a wall or an obstacle, the point at which noise occurs may be regarded as the wall or the obstacle, and the noise may be cancelled by producing a wavelength having a reverse phase on the wall or the obstacle.

Here, as a device for reproducing sounds, a speaker driver may be used, and a microphone module for picking up noise is also required.

Here, the microphone module may pick up noise, may perform reverse-phase processing on a picked-up noise signal, and may transfer the processed signal to the speaker driver, and the speaker driver may cancel the noise by outputting a signal obtained from reverse-phase processing.

However, sounds reproduced through the speaker driver may be picked up by the microphone module, and the picked-up sounds may be amplified by an amplifier and again output through the speaker driver.

This is called howling or feedback, and the feedback may easily occur when the microphone module is located in front of the voice coil of the speaker driver (on-axis state).

Therefore, generally, the speaker driver and the microphone module cannot be installed at the same position.

In addition, the feedback continuously increases the amount of amplification through the amplifier, thus damaging an amplification circuit, a power circuit, and the speaker driver.

The feedback easily occurs at a specific frequency, and may influence the overall frequency band as the bandwidth of a Quality factor (Q) value is widened.

Accordingly, a method for preventing the feedback is required using a method for blocking a frequency at which a feedback occurs using a graphic equalizer (EQ).

However, the above-described method is problematic in that frequency characteristics are distorted, so the reverse phase of the input frequency cannot be accurately processed, thus making it difficult to use the method in a noise elimination environment.

Also, when the microphone module and the speaker driver are installed at separate positions to prevent feedback, there are difficulties in that it is impossible to accurately pick up noise desired to be eliminated through the microphone module, and correction must be performed through a Digital Signal Processor (DSP) or the like.

The feedback occurs because both the speaker driver and the microphone module have certain directionality, and it is profitable that the speaker driver and the microphone module should be located in an off-axis state to prevent the feedback.

However, in the off-axis state, accurate sounds cannot be picked up, as described above, so the speaker driver and the microphone module should be located in an on-axis state, and a method capable of preventing a feedback is required.

Accordingly, an embodiment of the present disclosure may use a cover that is capable of blocking a magnetic field as the cover of the microphone module so as to prevent feedback even in an on-axis state, and may dispose the microphone module inside the diaphragm of the speaker driver, thus preventing feedback.

Referring to FIG. 14, the microphone-embedded speaker device according to an embodiment of the present disclosure may include a microphone module 1401 for picking up a sound from a medium and generating a pickup signal, a speaker driver 1403 for transferring a vibration corresponding to a reverse-phase signal of the pickup signal to the medium, and a controller for receiving the pickup signal from the microphone module 1401, generating the reverse-phase signal of the pickup signal, and transferring the reverse-phase signal to the speaker driver 1403.

Here, the microphone module 1401 may include a high-pitched sound contact microphone, a low-pitched sound contact microphone, a high-pitched sound boost plate, a low-pitched sound boost plate, a rubber plate, a feedback-blocking housing, etc.

Here, the speaker driver 1403 may include a magnet, a voice coil, a vibration unit, a fixing bracket, etc.

Here, in an embodiment of the present disclosure, the speaker driver 1403 may be installed at the same position as the microphone module 1401 so as to efficiently eliminate space noise.

The reason for installing the speaker driver 1403 at the same position as the microphone module 1401 is that a pickup position and a reproduction position are coincident with each other, thus reducing processing power required to correct a phase difference that may occur when the pickup position and the reproduction position are not coincident with each other, and minimizing an error.

For this operation, an embodiment of the present disclosure may present one device for disposing the microphone module 1401 inside the speaker driver 1403 for making a vibration and applying a feedback-prevention structure, thus simultaneously picking up a noise signal and reproducing a reverse-phase signal.

More specifically, the vibration unit of the speaker driver 1403 may have a parabolic shape, and the microphone module 1401 that is capable of separating a high-pitched sound and a low-pitched sound from each other and picking up the separate sounds may be installed in the vibration unit.

Here, the microphone module 1401 may be structurally separated such that it is not influenced by the vibration of the speaker driver 1403.

More specifically, the vibration unit of the speaker driver 1403 may include a microphone receiving part that is inwardly recessed on one side surface coming into contact with the medium, and the microphone module 1401 may be disposed in the microphone receiving part while being spaced apart from the vibration unit.

In addition, the vibration unit may further include a microphone module support pole, a first end of which is fixedly coupled to the microphone module 1401 and a middle end of which is coupled to the speaker driver 1403 so as to prevent the vibration of the speaker driver 1403 from being transferred to the microphone module 1401, wherein a rubber ring may be interposed between the microphone module support pole and the speaker driver 1403.

Through the above-described structure, the embodiment of the present disclosure may be arranged and operated such that the microphone module 1401 and the speaker driver 1403 are accurately seated in the medium to completely independently perform pickup and reproduction operations.

Also, the microphone module support pole enables the microphone module 1401 to be exactly adhered to the medium, and to be firmly attached to a targeted medium by applying an adhesive to a rubber plate.

Here, the feedback-blocking housing may accommodate the high-pitched sound contact microphone and the low-pitched sound contact microphone, may be formed of a magnetic-shielding material (in a magnetic-shielding type) so as to prevent the influence of an external magnetic field, and may be formed in a parabolic shape so as to improve a pickup rate.

Also, the embodiment of the present disclosure may include an integrated terminal for a connection between the speaker driver 1403 and the microphone module 1401.

Here, the microphone module 1401 may differently pick up center frequencies of sounds desired to be picked up by utilizing piezoelectric diaphragms having different sizes, such as the high-pitched sound contact microphone and the low-pitched sound contact microphone.

By means of this operation, the range of a targeted pickup frequency band may be widened.

Further, in the embodiment of the present disclosure, the pickup microphone module 1401 is installed at the same position as the speaker driver 1403, but the microphone module 1401 is implemented using a contact microphone (e.g., a piezoelectric microphone) to pick up only noise on a close contact surface without picking up noise in the air, thus preventing feedback from occurring.

Also, as described above, the microphone module 1401 may include a magnetic-shielding feedback-blocking housing so as to prevent the magnetic field of the speaker driver 1403 from influencing the microphone module, thereby preventing feedback attributable to the magnetic field from occurring.

Here, the vibration unit may be connected to a magnet, and may be driven in a moving-magnetic manner to transfer a vibration to the medium.

Here, the vibration of the vibration unit may exert no influence on the microphone module 1401 by means of the rubber ring.

Here, the fixing bracket may be connected to the voice coil holder of the speaker driver 1403 or the external housing of the speaker driver 1403, and may then be fixed to the medium.

In this case, the microphone module 1401 and the vibration unit may be mounted to be horizontal to the medium through the fixing bracket.

FIG. 15 is a conceptual diagram illustrating separation and elimination of a direct sound and an indirect sound according to an embodiment of the present disclosure.

Referring to FIG. 15, a noise elimination method according to an embodiment of the present disclosure may install multiple microphones in an array form while being spaced apart from each other by a certain distance, and may calculate the direction of a sound source and a distance to the sound source when a sound is picked up through the microphones.

Here, when the position at which noise occurs and the position of reproduction by a speaker are identical to each other, the noise may be simply cancelled using a reverse phase, whereas when the position of occurrence of noise and the position of reproduction by the speaker are different from each other, cancellation of noise using a reverse phase is impossible, and interference may occur instead.

Therefore, the detection of the position of the noise source enables a reverse wavelength to be accurately generated by adding distance and direction components.

Also, the noise elimination method according to the embodiment of the present disclosure may differently form separate wavelengths for respective frequencies using multiple speakers, and may generate different delay values and different wavelengths for respective speakers, thus enabling precise noise elimination.

Here, in the case of, for example, a ceiling 1500, an impact sound 1503 generated from a sound source 1501 may be directly transferred to the noise elimination device, and may be transferred thereto after being reflected (1505).

Here, a direct sound 1503 may be eliminated by a speaker driver 1509 closest to the sound source, and an indirect sound 1505 or a reflected sound may be eliminated by the remaining speaker drivers 1511.

In greater detail, in the noise elimination method, a reference microphone module that is the reference for pickup is placed at the center of the device, and n microphone modules may be arranged to be spaced apart from each other by a certain distance.

Here, the reference microphone module and the n microphone modules may analyze waveforms in detail through a spectrum analyzer, may calculate separate values based on phases, delays or levels, and may then detect the position and distance of occurrence of noise.

Here, the speaker driver that reproduces sounds to eliminate noise occurring at the detected position may be configured in a matrix form and divided into n speakers to perform reproduction in order to block a sound at the impact point using phase control and an auto-gain controller.

Here, because the noise elimination method according to the embodiment of the present disclosure may calculate the position and direction value of a noise source, incoming values through reflection or distorted values attributable to oscillation, diffraction or interference may be known, and thus additional processing may be further simplified.

Also, since an indirect sound has a delay compared to a direct sound, the difference between the direct sound and the indirect sound may be identified, whereby the noise elimination method may be applied differently depending on the difference, with the result that the efficiency of noise elimination may be improved.

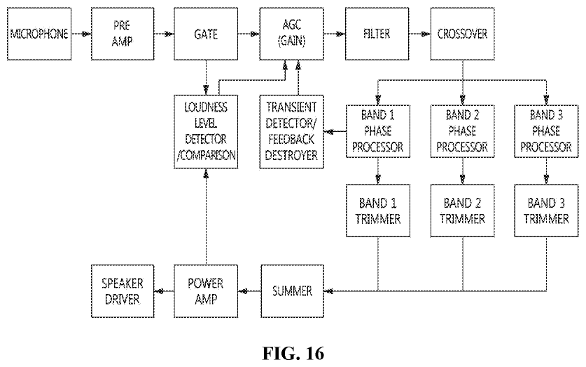

FIG. 16 is a flow diagram illustrating separation and elimination of targeted frequencies according to an embodiment of the present disclosure.

Referring to FIG. 16, a noise elimination method according to an embodiment of the present disclosure receives a pickup signal through a microphone.

Here, a gate (GATE) may determine an operating point by applying the average of ambient noise values.

Here, a loudness level detector/comparison unit (LOUDNESS LEVEL DETECTOR/COMPARISON) may control an auto-gain control value by comparing the pickup signal that is input through a pre-amplifier of the microphone with the output of a power amplifier.

Here, a filter (FILTER) may select only a valid frequency band aiming at processing, wherein a Low-Pass Filter (LPF) and a High-Pass Filter (HPF) for which specific frequency values are designated may be used as the filter.

Here, a crossover (CROSSOVER) may separate the frequency depending on the purpose of processing, and a Band-Pass Filter (BPF) may be applied for the crossover.

Here, band 1, band 2, and band N phase processors (BAND 1, BAND 2, BAND N PHASE PROCESSOR) may set up center frequencies depending on the targeted elimination frequency, may correct phases to respective center frequencies using delays, and may be subdivided into N phase processors depending on the necessity and accuracy thereof.

Here, band 1, band 2, and band N trimmers (BAND 1, BAND 2, BAND N TRIMMER) may again set up level compensation corresponding to phase correction of respective center frequencies, and may be subdivided into N trimmers depending on the necessity and accuracy thereof.

Here, a summer (SUMMER) may sum signals on which reverse-phase processing is performed, and may eliminate noise through a power amplifier and a speaker driver.

Here, a transient detector/feedback destroyer (TRANSIENT DETECTOR/FEEDBACK DESTROYER) may process an input signal as to whether the input signal has transient characteristics or has a feedback, recognize a signal having a sudden variation as having transient characteristics, recognize a gradually increasing signal as a feedback, and eliminate a feedback signal component by gating the feedback signal.

Also, the transient detector/feedback destroyer (TRANSIENT DETECTOR/FEEDBACK DESTROYER) may identify the types of signals using ADSR characteristics. By means of this, a frequency at which a feedback occurs may be determined in advance, and thus the feedback may be completely controlled.

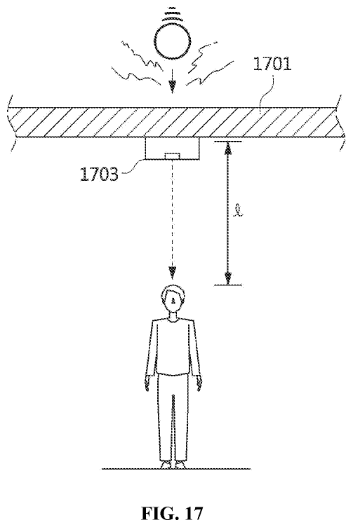

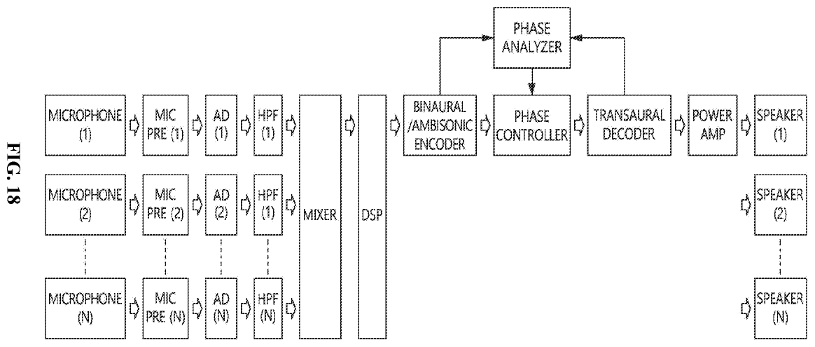

FIG. 17 is a diagram illustrating an example of elimination of transaural noise according to an embodiment of the present disclosure.

A noise elimination method according to an embodiment of the present disclosure may have difficulty in complete noise elimination because an impact sound may flow from additional devices other than a medium to which a noise elimination device is attached.

Elimination of high-pitched sounds may be partially eliminated using a honeycomb resonator, as described above, but noise may flow in a direction in which the noise elimination device is not attached.

Therefore, a transaural sound may be reproduced through a speaker driver installed in a direction opposite the direction of the medium to which the noise elimination device is attached.

Here, noise occurring in a space other than the medium may be predicted in advance through a separate pickup microphone, and the noise elimination device may eliminate noise in a specific space by producing a reverse phase transaural signal corresponding to the noise.

Here, the noise elimination device may analyze signals that are input through a reference microphone and N piezoelectric microphones, and may simulate the travel of waveforms based on a virtual hearing point.

Here, the position of a listener may be detected using a human body sensor, and detected data may be transferred to a position controller.

Here, the position of the listener may be a region from which noise is to be eliminated using a transaural processor.

The data to which processing is applied through the DSP may be transferred to a front speaker through the transaural processor.

Here, a transaural signal for noise elimination based on the hearing point may be generated, and noise at the hearing point may be cancelled.

However, the degree of noise reduction at the hearing point may be controlled by the user through a wired/wireless device.

Here, hearing points occurring when there are multiple listeners may be designated as suitable points through the wired/wireless device.

Referring to FIG. 17, a noise elimination method may predict a sound wave to be transferred by distance L in a normal situation if the distance from a point 1701 at which noise occurs to a hearing point is designated as L. Here, when elements such as the amount of noise flowing through an additional medium or a wall surface, a delay, and a wavelength, are added, the shape of a sound wave to be formed at the hearing point may be predicted.

As a result, the noise elimination method may eliminate noise by exploiting the prediction value as a parameter for the transaural processor.

Here, a transaural speaker 1703 may be implemented as an array of one or more speakers, and may generate a transaural sound image based on the hearing point.

Also, in order to extend a region to which the transaural sound image is applied, a plurality of transaural speaker sets may be mounted on the corresponding device.

FIG. 18 is a flow diagram illustrating elimination of noise using a multi-microphone structure according to an embodiment of the present disclosure.

Referring to FIG. 18, the multi-microphone structure may be composed of one or more microphones based on a micing method for acquiring stereophonic sound.

For example, BINAURAL may be composed of two microphones, AMBISONIC may be composed of four or more microphones, and multi-XY may be composed of eight or more microphones.

Here, a pickup signal having passed through MIC PRE and AD blocks may pass through a High-Pass Filter (HPF) for eliminating frequencies equal to or less than 1 kHz, and may be transferred to a mixer.

Here, the mixer (MIXER) may process the pickup signal that is input through a bus using a panning or level (PANNING or LEVEL) block.

Here, a DSP may perform audio digital signal processing (DSP) through a compressor, a gate, an equalizer (COMPRESSOR, GATE, or EQ) or the like.

Here, a binaural/ambisonic encoder (BINAURAL/AMBISONIC ENCODER) may perform monitoring on finally processed audio, and may apply encoding to the monitored audio using a stereophonic pickup method.

Here, a phase analyzer (PHASE ANALYZER) may analyze phase between the encoded data and transaural decoding, and may exactly match the phases with each other.

Here, a phase controller (PHASE CONTROLLER) may apply a reverse phase to the analyzed phase through the analyzer.

Here, the signal processed in the binaural or ambisonic manner may be reproduced as a transaural sound through a transaural decoder, a power amplifier, and a speaker (TRANSAURAL DECODER, POWER AMP, and SPEAKER).

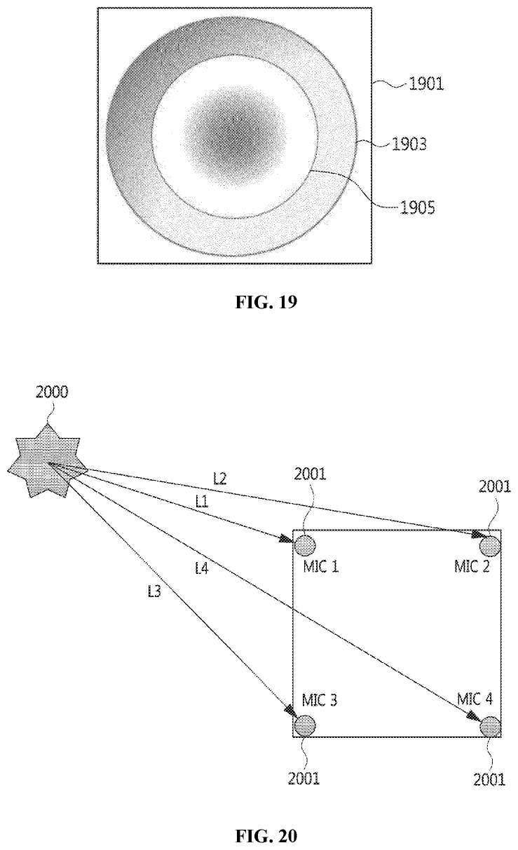

FIG. 19 is a diagram illustrating an example of an operating state via a display device according to an embodiment of the present disclosure.

A noise elimination device may prevent noise from being transferred to a user when noise between floors occurs, and may check whether the corresponding device is operated.

Also, the operating state of the device may be recorded according to time and date, and may be used to determine the frequency of occurrence of noise between floors, and such data may be utilized and applied to the environment of the user in a customized form.

Referring to FIG. 19, a noise elimination device may include a display 1901 divided into multiple areas, and may indicate whether a direct sound is processed, whether an indirect sound is processed, etc., via the divided display 1901.

Here, a monitor for processing a direct sound may be an inner circle 1905, may represent the amount of application of noise elimination based on the center, and may have directionality of processing.

Here, a monitor for processing an indirect sound may be an outer circle 1903, may represent the amount of noise eliminated in the direction from the outside to the center, and may recognize directionality of processing.

Such a display method is not limited to the above-described example, and may change a color and information of whether the display is to be turned on or off depending on the user's settings.

Here, the operating state of the noise elimination device may be recorded according to time, and the user may monitor the operating state using a display or a smart phone, and may check the records on an hourly, daily, monthly or yearly basis.

Here, the records may be used as data for improving the operating quality of the device. For example, the maximum value and the minimum value of the degree of occurrence may be compared with each other, and may be used as threshold or gating parameters enabling the operation of the device to be more precisely maintained when an average value is known.

Also, the records may be used as evidential data attributable to disputes over noise between floors.

Further, the noise elimination device may be used to provide data of a power management system that can stop the operation thereof during a time in which the user is away from home, or can continue to perform operation during a period in which noise between floors is concentrated.

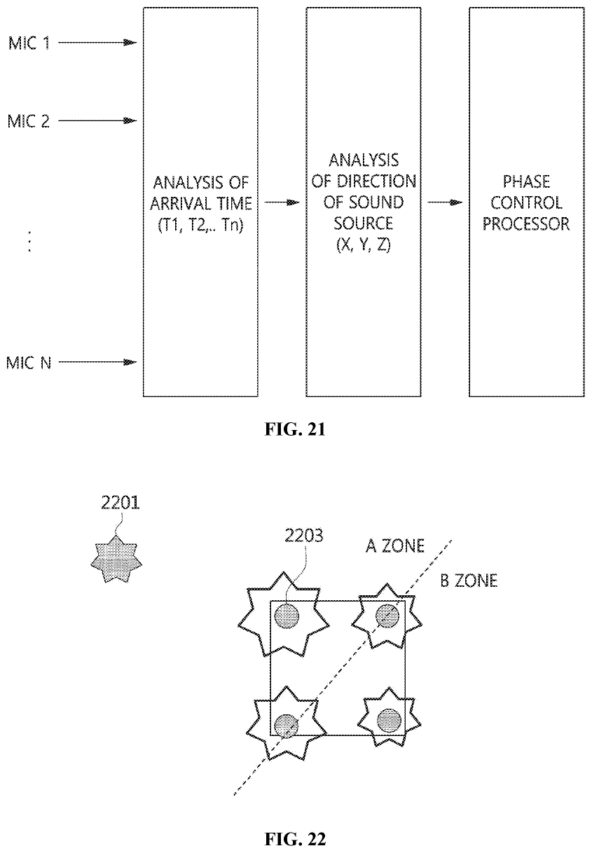

FIG. 20 is a conceptual diagram illustrating calculation of the position of a sound source 2000 through multiple microphones 2001 according to an embodiment of the present disclosure, and FIG. 21 is a flowchart illustrating calculation of the position of the sound source 2000 according to an embodiment of the present disclosure.

Referring to FIGS. 20 and 21, the embodiment of the present disclosure may calculate a direction in which a sound is produced by analyzing levels of microphones using two or more microphones 2001.

Also, the embodiment of the present disclosure may analyze the difference between the times of the microphones using two or more microphones 2001 and may then calculate the distance at which the sound occurs.

Here, the embodiment of the present disclosure may perform a more accurate operation when the sound is limited to a specific sound occurring in a specific medium (e.g., ceiling or the like).

FIG. 22 is a conceptual diagram illustrating classification of sound processing depending on the position of a microphone according to an embodiment of the present disclosure.

Referring to FIG. 22, the noise elimination method may output the reverse phase of the corresponding waveform through a speaker driver 2203 closest to a sound source 2201 depending on the direction and distance of the sound source.

Here, in zone B, interference may occur due to a calculation error for the distance to a sound source or for the wavelength.

Therefore, the remaining speaker drivers other than the sound source closest to the sound source may output audio signals to which the deformation of phase for suppressing interference is applied, thereby preventing noise from flowing into zone A.

Therefore, the noise elimination method according to the embodiment of the present disclosure may create a further flattened waveform in spite of dispersion of sound using the multiple speakers.

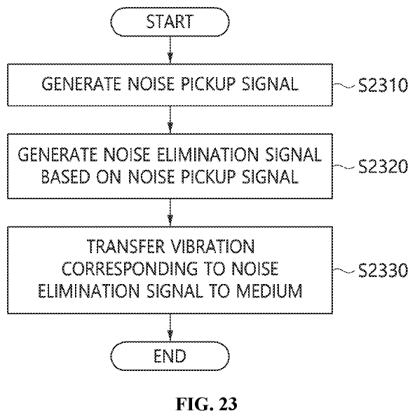

FIG. 23 is a flowchart illustrating a noise elimination method according to an embodiment of the present disclosure.

Referring to FIG. 23, a noise elimination method according to an embodiment of the present disclosure picks up a sound from a medium through a pickup microphone module, and generates a noise pickup signal, in a method for eliminating noise using a noise elimination device, at step S2310.

Next, the noise elimination method according to the embodiment of the present disclosure generates a noise elimination signal based on the noise pickup signal at step S2320.

Further, the noise elimination method according to the embodiment of the present disclosure transfers a vibration corresponding to the noise elimination signal to the medium through a speaker driver at step S2330.

Here, the pickup microphone module may be configured such that multiple pickup microphone modules are attached to the medium, and step S2320 of generating the noise pickup signal may include detecting a direction corresponding to noise using the noise pickup signals that are picked up through the multiple pickup microphone modules, and generating the noise elimination signal based on the direction.

Here, step S2320 may include the step of calculating the position of the sound source corresponding to the noise based on the noise pickup signals and the step of generating the noise elimination signal based on the position of the sound source.

The speaker driver may be provided with multiple speaker drivers, and the noise elimination method may further include the step of calculating distances from respective multiple speaker drivers to the sound source, and the step of applying a delay corresponding to at least one of the distances to a noise elimination signal corresponding to at least one of the multiple speaker drivers.

Here, step S2330 may include the step of transferring a vibration, corresponding to the noise elimination signal for eliminating noise corresponding to the sound source, to the medium through some of the multiple speaker drivers, and the step of transferring an attenuation vibration for attenuating the vibration to the medium through some other of the multiple speaker drivers.

Here, the noise cancellation method may further include the step of eliminating sound leakage and noise occurring on rear surface of each speaker driver through a honeycomb resonator that accommodates the pickup microphone module and the speaker drivers.

Here, an internal space of the honeycomb resonator is divided into honeycomb cell structures, wherein a partition defining one or more honeycomb cell structures as one space may be formed.

Here, the honeycomb resonator may be configured such that, in order to increase diffuse reflection of noise absorbed in the honeycomb resonator, the heights of bottom surfaces of respective honeycomb cell structures formed in the honeycomb resonator are differently formed.

Here, in the partition, through-holes having a size corresponding to a frequency desired to be removed from the space formed by the partition may be formed.

Here, step S2320 may include the step of calculating a first fundamental frequency value based on the noise pickup signal, the step of generating a first noise elimination signal corresponding to the first fundamental frequency value, the step of calculating a second fundamental frequency value based on a noise pickup signal from which a wavelength corresponding to the first fundamental frequency value is removed, and the step of generating a second noise elimination signal corresponding to the second fundamental frequency value.

Here, at step S2330, vibrations corresponding to the first noise elimination signal and the second noise elimination signal may be sequentially transferred to the medium through the speaker driver.

Here, step S2320 may include the step of predicting a Chladni pattern based on the structure information of the medium input by the user, and the step of generating the noise elimination signal based on the pattern and the noise pickup signal.

Here, step S2320 may include the step of calculating a fundamental frequency value and harmonic frequency values based on the noise pickup signal, the step of simultaneously generating waveforms corresponding to the fundamental frequency value and the harmonic frequency values, and the step of generating the noise elimination signal based on the waveforms.

The noise elimination device according to an embodiment of the present disclosure may be attached to and used in a wall or a ceiling that support a building, thus relatively easily detecting the shaking of the building.

Therefore, the noise elimination device according to an embodiment of the present disclosure may be equipped with a sensor capable of detecting an earthquake, thus providing a function of notifying a user of the occurrence of an earthquake in the event of the earthquake.

In this case, the noise elimination device according to an embodiment of the present disclosure may provide an alarm and turn on an emergency sensor light when an abnormal vibration such as an earthquake is detected, and may reset the operation depending on the user's settings when the situation is terminated.

Further, the noise elimination device according to an embodiment of the present disclosure may include one or more of sensors for temperature, humidity, oxygen concentration, fine dust concentration, fire sensing, and gas sensing, by which, in the event of an abnormal situation, an alarm is provided in a visual or audible manner to a user so that the user recognizes the situation, and emergency may be directly reported to a fire station in cooperation with a firefighting instrument in the event of emergency such as the occurrence of a fire.

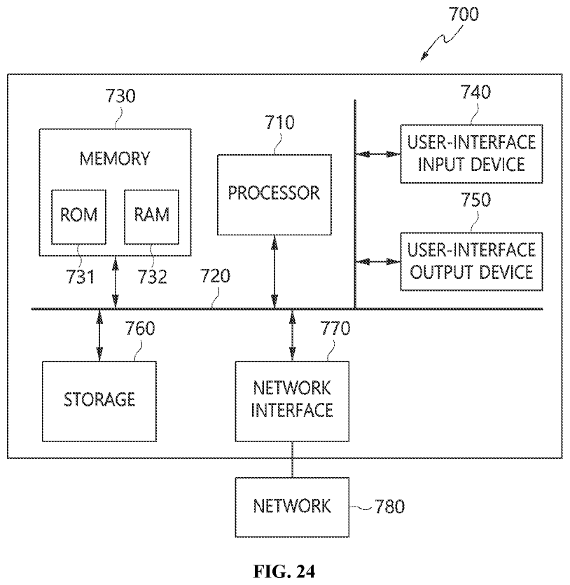

FIG. 24 is a diagram illustrating a computer system according to an embodiment of the present disclosure.

Referring to FIG. 24, at least some components of the noise elimination device according to an embodiment of the present disclosure may be implemented in a computer system 700, such as a computer-readable storage medium. As illustrated in FIG. 24, the computer system 700 may include one or more processors 710, memory 730, a user-interface input device 740, a user-interface output device 750, and storage 760, which communicate with each other through a bus 720. The computer system 700 may further include a network interface 770 connected to a network 780. Each processor 710 may be a Central Processing Unit (CPU) or a semiconductor device for executing processing instructions stored in the memory 730 or the storage 760. Each of the memory 730 and the storage 760 may be any of various types of volatile or nonvolatile storage media. For example, the memory 730 may include Read-Only Memory (ROM) 731 or Random Access Memory (RAM) 732.

As described above, in the noise elimination device and method according to the present disclosure, the configurations and schemes in the above-described embodiments are not limitedly applied, and some or all of the above embodiments can be selectively combined and configured such that various modifications are possible.

1. A noise elimination device, comprising:
one or more pickup microphone modules for picking up a sound from a medium and generating a noise pickup signal;
one or more speaker drivers for transferring a vibration corresponding to a noise elimination signal generated based on the noise pickup signal to the medium; and
a controller for generating the noise elimination signal based on the noise pickup signal.

2. The noise elimination device of claim 1, wherein the pickup microphone modules are configured such that:
multiple pickup microphone modules are attached to the medium, and
a direction corresponding to noise is detected using noise pickup signals picked up through the multiple pickup microphone modules, and the noise elimination signal is generated based on the direction.

3. The noise elimination device of claim 2, wherein the noise pickup signals are used to calculate a position of a sound source corresponding to the noise, and the noise elimination signal is generated based on the position of the sound source.

4. The noise elimination device of claim 3, wherein the one or more speaker drivers comprise multiple speaker drivers and are configured to calculate distances from respective multiple speaker drivers to the sound source and apply a delay corresponding to at least one of the distances to a noise elimination signal corresponding to at least one of the multiple speaker drivers.

5. The noise elimination device of claim 4, wherein a part of the multiple speaker drivers are configured to generate the noise elimination signal for eliminating the noise corresponding to the sound source, and a remaining part of the multiple speaker drivers are configured to generate an attenuation vibration required to attenuate the vibration for eliminating the noise.

6. The noise elimination device of claim 5, wherein the multiple pickup microphone modules and the multiple speaker drivers are installed in a single structure attached to the medium.

7. The noise elimination device of claim 1, further comprising:
a honeycomb resonator for accommodating the one or more pickup microphone modules and the one or more speaker drivers and eliminating sound leakage occurring on rear surfaces of the one or more speaker drivers and low-level noise transferred from the medium.

8. The noise elimination device of claim 7, wherein the honeycomb resonator is configured such that an internal space thereof is divided into honeycomb cell structures and a partition defining one or more honeycomb cell structures as one space is formed.

9. The noise elimination device of claim 7, wherein the honeycomb resonator is configured such that, in order to increase diffuse reflection of the sound leakage and the low-level noise that are internally absorbed, heights of bottom surfaces of respective honeycomb cell structures formed in the honeycomb resonator are differently formed.

10. The noise elimination device of claim 8 wherein the partition is configured such that a through-hole having a size corresponding to a frequency desired to be removed from the internal space formed by the partition is formed in the partition.

11. The noise elimination device of claim 1, wherein each of the one or more speaker drivers further comprises:
a resonance unit coupled to a rear surface of a corresponding speaker driver and formed in a multi-chamber manner to cancel sound leakage occurring in the rear surface of the corresponding speaker driver.

12. The noise elimination device of claim 3, wherein:
the controller is configured to:
calculate a first fundamental frequency value based on the position of the sound source and the noise pickup signal, generate a first noise elimination signal corresponding to the first fundamental frequency value, and transfer the first noise elimination signal to a corresponding speaker driver, and
calculate a second fundamental frequency value based on a noise pickup signal from which a wavelength corresponding to the first fundamental frequency value is removed, generate a second noise elimination signal corresponding to the second fundamental frequency value, and transfer the second noise elimination signal to the corresponding speaker driver, and
the corresponding speaker driver is configured to transfer vibrations corresponding to the first noise elimination signal and the second noise elimination signal, transferred from the controller, to the medium in a time-series order.

13. The noise elimination device of claim 1, wherein the controller is configured to predict a Chladni pattern based on information about a structure of the medium, input by a user, and generate the noise elimination signal based on the Chladni pattern and the noise pickup signal.

14. The noise elimination device of claim 3, wherein the controller is configured to calculate a fundamental frequency value and a harmonic frequency value based on the position of the sound source and the noise pickup signal, simultaneously generate waveforms corresponding to the fundamental frequency value and the harmonic frequency value, and generate the noise elimination signal based on the simultaneously generated waveforms.

15. A noise elimination method for eliminating noise using a noise elimination device, comprising:
picking up a sound from a medium through a pickup microphone module and generating a noise pickup signal;
generating a noise elimination signal based on the noise pickup signal; and
transferring a vibration corresponding to the noise elimination signal to the medium through a speaker driver.

16. The noise elimination method of claim 15, wherein:
the pickup microphone module is configured such that multiple pickup microphone modules are attached to the medium, and
generating the noise elimination signal comprises:
detecting a direction corresponding to noise using noise pickup signals picked up through the multiple pickup microphone modules, and generating the noise elimination signal based on the direction.

17. The noise elimination method of claim 16, wherein generating the noise elimination signal comprises:
calculating a position of a sound source corresponding to the noise based on the noise pickup signals; and
generating the noise elimination signal based on the position of the sound source.

18. The noise elimination method of claim 17, wherein:
the speaker driver comprises multiple speaker drivers, and
the noise elimination method further comprises:
calculating distances from respective multiple speaker drivers to the sound source; and
applying a delay corresponding to at least one of the distances to a noise elimination signal corresponding to at least one of the multiple speaker drivers.

19. The noise elimination method of claim 18, wherein transferring the vibration to the medium comprises:
transferring a vibration corresponding to the noise elimination signal for eliminating noise corresponding to the sound source to the medium through a part of the multiple speaker drivers; and
transferring an attenuation vibration required to attenuate the vibration to the medium through a remaining part of the multiple speaker drivers.

20. The noise elimination method of claim 15, further comprising:
eliminating sound leakage and noise occurring on a rear surface of the speaker driver through a honeycomb resonator that accommodates the pickup microphone module and the speaker driver.

21.-26. (canceled)
